(19) United States
(12) Patent Application Publication
(10) Pub. No.: US 2004/0215704 A1
(43) Pub. Date: Oct. 28, 2004

(54) Coupler for a data processing apparatus

(76) Inventors: Bartholomaus Kellerer, Munchen (DE); Hans Kuebler, Gilching (DE); Manfred Reitenspiess, Siegertsbrunn (DE)

Correspondence Address: LERNER AND GREENBERG, PA, P O BOX 2480, HOLLYWOOD, FL, 33022-2480, US

(21) Appl. No.: 10/774,726

(22) Filed: Feb. 9, 2004

Related U.S. Application Data
(63) Continuation of application No. PCT/DE02/02713, filed on Jul. 24, 2002.

(30) Foreign Application Priority Data
Aug. 7, 2001 (DE) 101 38 658.3

(51) Int. Cl. G06F 15/16

(52) U.S. Cl. 709/201

(57) ABSTRACT

A coupler for a data processing apparatus couples a first data processing apparatus (which is connected to a network) to at least one second data processing apparatus (which is likewise connected to the network, and has a further coupler), with the second data processing apparatus not being identified in the network. The coupler is characterized in that it provides, in conjunction with the second data processing apparatus, functions that increase availability.

### CROSS-REFERENCE TO RELATED APPLICATION

This application is a continuation of copending International Application No. PCT/DE02/02713, filed Jul. 24, 2002, which designated the United States.

### BACKGROUND OF THE INVENTION

Field of the Invention

The invention relates to coupler for a data processing apparatus for coupling a first data processing apparatus (which is connected to a network) to at least one second data processing apparatus (which is likewise connected to the network, and has a coupler), with the second data processing apparatus not being identified in the network.

Conventional networks are used, above all, in telecommunications. These networks are characterized in that they have “end-to-end control”. That is to say, the physical connection can be established from the starting point to the end point. The status of the network elements is always clearly defined. Networks of this type have the advantage that it is possible to implement very reliable transmission paths by routing the transmission only via extremely reliable components. This is therefore achieved by virtue of the extremely high reliability of the individual network components and by virtue of a highly developed and thus expensive network management system.

The disadvantage of networks of this type is, on the one hand, the high complexity and, on the other hand, a performance limitation as a result of the rigid definitions of the device parameters. This ultimately leads to a high cost/performance ratio.

A further disadvantage resides in the fact that the services that can be provided in the network are defined by the network and the elements themselves and are thus available to a very limited extent only. Customer-related and flexible services cannot be provided in a network of this type.

Internet Protocol (IP) networks that also satisfy the new requirements for services that are to be provided were set up within the context of connecting previously separate networks. The IP networks are connected to intelligent nodes, a multiplicity of servers and data stored on the latter, which can interact for the purpose of carrying out a service. Data is transmitted in packets. In this case, a volume of data to be transmitted is divided into individual packets that are transported separately. The packets are reassembled in the receiver. The data processing apparatuses are not identified in the network. A network having data processing apparatuses that are not identified is to be understood to mean those networks in which the individual data processing apparatuses are not registered at a central location where they can be configured. “Clusters”, in contrast, do not fall into this network category since, in cluster networks, the individual data processing apparatuses are exactly known and configured. In this case, the exact hardware configuration and the type of systems are of fundamental importance for the operability of the data processing apparatuses that have been joined together.

IP networks (which are those networks having data processing apparatuses that are not identified) result in completely new boundary conditions for providing services in networks. Services are not necessarily dependent on transport mechanisms in the network. It is possible to transmit multimedia contents. Since data does not have to be transmitted in real time, transmission may be effected using a dynamic bandwidth that may be changed even during a service. In this case, the transport of data and the service are separate from one another and may be supplied by different providers. In this case, a service may be addressed both logically and in accordance with content.

However, IP networks also have disadvantages. End-to-end control within the network and the associated capability of providing high-availability connections and nodes are thus not possible since the nodes (via which the data is transported) within the network can be defined dynamically. Whereas, in classic telecommunications networks, the entire network or at least a large part of the network is owned and administered by one operator, in an IP network the network elements, services and associated contents belong to many different owners. Therefore end-to-end control is not possible. Restricting the network to only very powerful components in order to achieve high availability contradicts the openness of the network and free access to service and also the free introduction of service into the network. Cost advantages resulting from the ability to integrate any desired components would be lost.

The problem with IP networks is thus that it is not possible to guarantee the high availability that is often required. Increasing the availability of an individual network node does not sufficiently increase the overall system reliability of all the components that are required or used to provide a service. The reliability of all the network components in question cannot be established since there are too many of them and, furthermore, they may be distributed throughout the world. Neither is it possible to achieve reliability by carrying out end-to-end control since the latter is not provided in an IP network and the requisite administration procedures are not available.

One known solution to the problem is to adopt concepts from classic telecommunications networks and their use in IP networks. Accordingly, vulnerable intercontinental connections, for example, may be provided by a particular operator and the remaining intercontinental paths may be handled via the Internet. The selection of the particular operator by a user makes it possible for the latter to ensure that the connection via the IP network satisfies certain quality criteria. However, the flexibility of the IP network is then lost again.

“Intelligent networks” are another possible solution. In these networks, the type of services that may be provided is limited. Intelligent networks are supported on central databases and form a layer that is superordinate to a telephone network. The availability of the central databases may be ensured by the use of cluster techniques at selected large service nodes. However, this results in extremely large service nodes and at best influences the operation of a single node.

However, the “intelligence” of future IP-based networks will not be restricted to central nodes but will be distributed among all network components in the IP network, with the result that measures on individual nodes will be far from sufficient.

A further problem resides in the fact that only the availability of the hardware is improved by equipping the hardware with functions that increase availability. However, the flexibility of a service generally depends on the software implementation, in which case it should be noted that approximately 40% of all faults are due to software. Purely improving the hardware situation thus only partly contributes to increasing the availability of a service.

It is customary practice in e-commerce to replicate nodes one or more times in order to lessen the effects of a node failing. However, this concept, applied to a single node, is not sufficient in the case of complex services since a greater number of nodes are required to provide a service of this type.

### SUMMARY OF THE INVENTION

It is accordingly an object of the invention to provide a coupler for a data processing apparatus which overcomes the above-mentioned disadvantages of the prior art devices of this general type, which can be used to connect a data processing apparatus to a network and which make it possible to provide services in a highly reliable manner.

With the foregoing and other objects in view there is provided, in accordance with the invention, a coupler for coupling a first data processing apparatus connected to a network, to at least one second data processing apparatus also connected to the network and having a further coupler. The second data processing apparatus is not identified in the network. The first data processing apparatus is associated with a first network node and the second data processing apparatus is associated with a second network node within the network. The coupler, in conjunction with the second data processing apparatus of the second network node, provide functions for increasing availability.

The object is achieved by a coupler for a data processing apparatus of the type mentioned initially which is characterized in that the coupler, in conjunction with the second data processing apparatus, provide functions which increase availability.

The inventive coupler makes it possible to equip any desired data processing apparatuses (which are not identified in a network) in such a manner that it is possible to achieve increased availability by virtue of the interaction of the data processing apparatuses. The combination of a plurality of data processing systems using the inventive coupler in order to provide functions that increase availability is referred to below as a “virtual cluster”.

The advantage of the inventive coupler thus resides in the fact that it is possible to use standard hardware components that are not subject to any particular requirements. There is no need to match the hardware of the data processing apparatuses.

A further advantage resides in the fact that the coupler may be added by remote installation since it may be a pure software component. Various data processing apparatuses can therefore be provided with the inventive coupler merely from one location in order to set up a network having data processing apparatuses that are not identified in the network. A network that has high-availability properties can thus be set up from a central location.

Furthermore, in comparison with conventional clusters in which a data processing apparatus can belong to only one cluster, there is the advantage, in a “virtual cluster” having the inventive coupler (hardware and/or software), that a data processing apparatus may also belong to a plurality of logical clusters.

In accordance with an added feature of the invention, the functions for increasing availability are provided automatically.

In accordance with an additional feature of the invention, the coupler is set up such that the functions for increasing availability can be administered from another network node.

In accordance with another feature of the invention, the functions for increasing availability of the coupler in the first data processing apparatus carry out memory replication from the first data processing apparatus to the second data processing apparatus.

In accordance with a further feature of the invention, the functions for increasing availability carry out a parallel calculation in the first data processing apparatus and in the at least one second data processing apparatus.

In accordance with another added feature of the invention, the functions for increasing availability initiate translation of physical addresses of the at least one second data processing apparatus, the physical addresses being predefinable or automatically determinable, into logical addresses, with a translation being carried out by the first data processing apparatus.

In accordance with another additional feature of the invention, the functions for increasing availability route event and alarm messages through the same channels, with the event and alarm messages being centrally accessible, so that suitable countermeasures including termination of a service, may be initiated automatically or manually.

In accordance with another further feature of the invention, the functions for increasing availability of the coupler in the first data processing apparatus provide timer objects of the at least one second data processing apparatus in redundant form.

In accordance with the invention, the functions for increasing availability of the coupler in the first data processing apparatus monitors the addressability of the at least one second data processing apparatus.

In accordance with a preferred embodiment of the invention, the coupler terminates the functions for increasing availability by coupling to the at least one second data processing apparatus which can no longer be addressed.

In accordance with a concomitant feature of the invention, the functions for increasing availability of the coupler in the first data processing apparatus automatically install an administration program unit from the first data processing apparatus to the at least one second data processing apparatus.

With the foregoing and other objects in view there is further provided, in accordance with the invention, a data processing apparatus. The apparatus contains a communication interface for connecting the data processing apparatus associated with a first network node to a network; and a coupler for providing functions for increasing availability in conjunction with at least one further data processing apparatus associated with a second network node. The further data processing apparatus being connected to the network, has a further coupler, and is not identified.

Other features which are considered as characteristic for the invention are set forth in the appended claims.

Although the invention is illustrated and described herein as embodied in a coupler for a data processing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an illustration of a basic structure of an IP network when handling a service that is distributed among a plurality of nodes;

FIG. 2 is a block diagram of a structure of a node having a conventional cluster;

FIG. 3 is a block diagram of a configuration of a network having a plurality of nodes with the inventive coupler; and

FIGS. 4 to 7 are illustrations showing various phases in the handling of a service when using nodes with the inventive coupler.

### DESCRIPTION OF THE PREFERRED EMBODIMENTS

Referring now to the figures of the drawing in detail and first, particularly, to FIG. 1 thereof, a user of computer A, referred to below as “client”, requests a service in an IP network. The IP network is a network having nodes that are not identified, as explained in the introduction to the description. The request from client A first arrives at a node K1 that cannot provide the requested service on its own. The node K1 therefore forwards a further request to a node K2 to provide that part of the service that the node K1 cannot manage to do. The node K2 is likewise not capable of providing all the services for satisfying the request of client A and therefore forwards a subtask to node K3. A chain of 3 nodes K1 to K3 is therefore required in order to satisfy the request of client A.

The nodes K1 to K3 generally neither belong to a single owner nor do they contain the same hardware and software. The reliability of the nodes K1 to K3 is thus generally very different. The node K3 could, for example, be a cluster containing a plurality of servers, the cluster handling payment transactions at a bank in order to settle accounts for the service requested by client A. A high-availability cluster can achieve a reliability level of 99.999% in this case, corresponding to a downtime of 5 minutes per year. From the point of view of client A, however, only the reliability of the entire chain containing the three nodes K1, K2 and K3 is important. If only the node K3 has been equipped to have a high level of availability, this does not necessarily result in a high level of availability for the entire service.

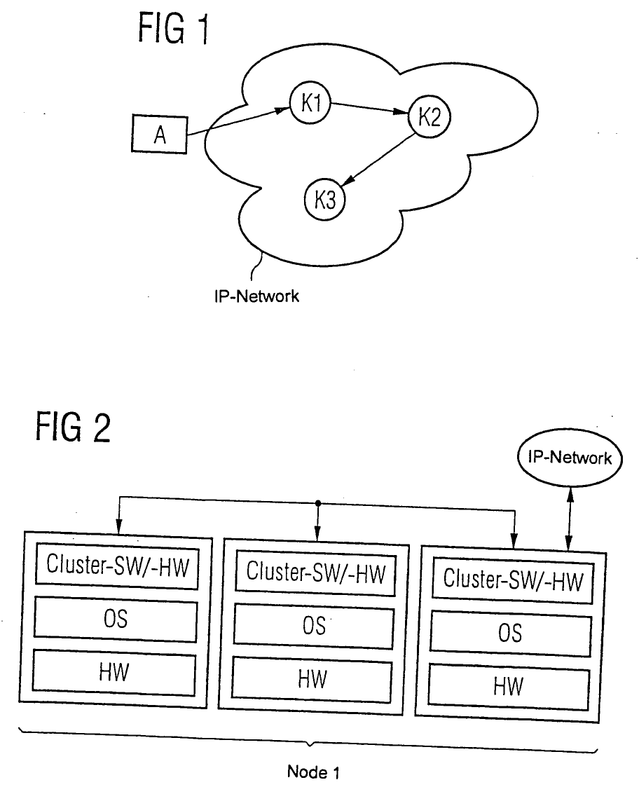

It is conceivable to use a cluster solution as shown in FIG. 2 in order to make an individual node have a high level of availability. Every server in the cluster has hardware HW, an operating system OS and cluster software or hardware, respectively. The servers are connected to one another, with the cluster software/hardware controlling functions that increase availability.

All of the various servers, that is to say the cluster, are then connected to a network, to an IP network in the present case. The node thus has a high level of availability by virtue of the fact that measures have been provided locally for the purpose of increasing availability. In this context, the term “locally” may also mean, for example, an in-house network in which a plurality of servers are connected to form a cluster even though they are disposed in a spatially separate manner. In this sense, locally is thus to be understood as meaning that the hardware and system configuration are known and have been matched to one another. Joint system and cluster administration is carried out. All data in the cluster is known and may be retrieved at a central location.

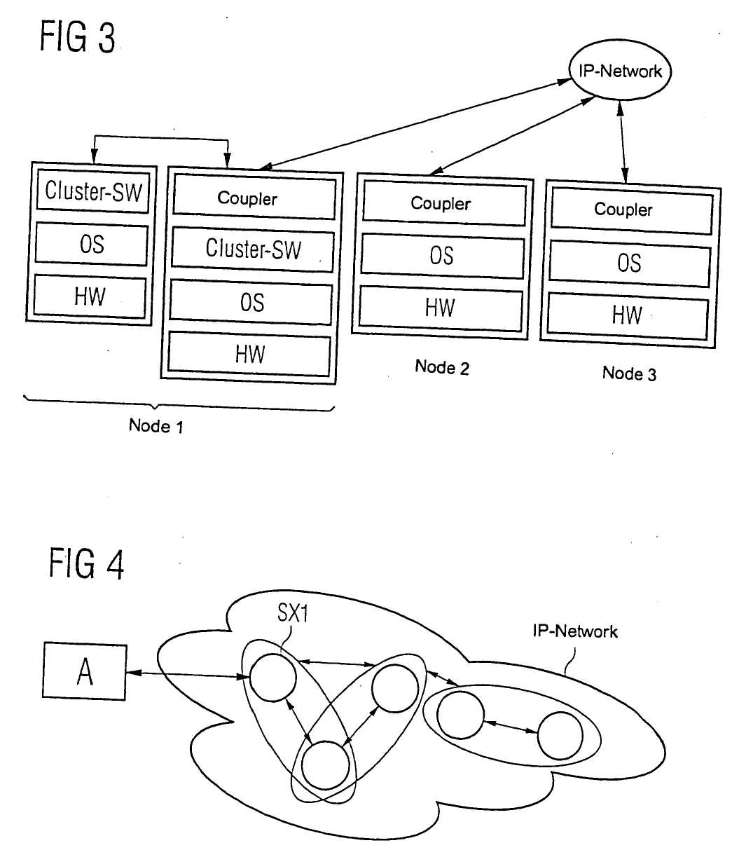

FIG. 3 shows a high-availability configuration, as could be produced in accordance with the invention. There are nodes (node 1) which, as previously, have been configured to have a high level of availability by use of local measures. The availability of the node 1 can be increased further by providing additionally the inventive coupler that makes it possible to implement availability-increasing functions via the IP network in conjunction with other nodes.

A simple node which itself does not contain a local cluster can likewise be made to have a high level of availability by adding the coupler which enables coupling to other nodes and thus make it possible to implement functions which increase availability. In the example of FIG. 3, coupling of the nodes 2 and 3 using the inventive coupler and the IP network may result in just as high an availability level as a local cluster at node 1, when considered on its own.

The scope of functions of the coupler is configured in such a manner that customary functions of a local cluster are also available for inventive virtual clusters. In the event that the couplers are additionally used in a local cluster, functions that increase availability are available both at a local level and via the IP network.

The functions that increase availability may, for example, involve providing methods for memory replication to the second data processing apparatus. The memory of a data processing apparatus is thus always mapped onto the second data processing apparatus, so that, if the first data processing apparatus fails or a fault occurs therein, it is possible to fall back on the memory replica in order to restore the state before the fault occurred. A second capability of functions that increase availability involves calculations being carried out in parallel on the first data processing apparatus and on a second data processing apparatus and the result then being compared. If the results are different, it may be concluded that there is a fault and appropriate fault handling measures may be initiated. It is furthermore customary practice, as a function that increases availability, to provide timer objects in redundant form. In addition, it is possible to reciprocally monitor the addressability of the respective other data processing apparatus. This makes it possible to ascertain when one of the data processing apparatuses is no longer working correctly, and the other data processing apparatus can assume processing of the tasks to be dealt with. It is optionally possible to take action on the other data processing apparatus to such an extent as to terminate an application that is no longer working.

However, it is also possible, at this point, to provide many other functions with which the person skilled in the art is familiar and which are therefore covered by the invention. All of these functions may be implemented using software. A tremendous advantage of the inventive coupling device or method thus resides in the fact that it is not necessary to take any significant action on the system. It is furthermore advantageous that the coupler may be installed remotely. This is important, above all, when it is not possible to actually physically access the other data processing apparatuses, which will be the norm with an IP network such as the Internet. It is noted that the coupler may be in the form of pure software, software/hardware or pure hardware.

The manner in which the capabilities of inventive coupler are used is explained below with reference to an example.

The example relates to a travel reservation service. In this case, a trip (initially not determined in any more detail) is to be booked and paid for. A user on client A sends an inquiry to a first node SX1 in an IP network (FIG. 4). This node may be, for example, the server of a service provider.

The following tasks must be carried out in order to fully book a trip:

a) identification of a trip by inquiring with various service providers;

b) selection of some trips of interest and determination of the price by accessing the corresponding service providers;

c) selection of a trip and execution of the booking; and

d) preparation of the travel documents for the customer and billing of the customer.

As shown in FIG. 4, various servers of various service providers will have to collaborate in the course of carrying out these subtasks.

In FIG. 5, the user on computer or client A consults the service provider node SX1. SX1 may, for example, be the website of a tour operator. Client A is a PC that has been equipped to interchange data with the Internet. Following contact with SX1, SX1 realizes that carrying out the requested travel service will place high demands on availability. Following failure of the server, the operator would possibly lose the customer and the turnover to be achieved thereby.

Therefore, it must be ensured that the service proceeds in a high-availability environment. Instead of equipping the node so as to have a high level of availability, as shown in FIG. 2, the node SX1 consults two neighboring nodes SU and SX2 which are known to the node SX1 and are likewise able to carry out the “travel reservation” service.

The manner in which the nodes that can provide the same service are recognized does not form the subject matter of the invention and is not explained any further here. One simple option is to administer services of this type using common tables that can be reciprocally updated in the event of changes. It is likewise assumed that the table lists only those nodes on which the addressed service has already been installed. However, there could also be a relationship that allows the node SX1 to install the service remotely. This approach is used, for example, in peer-to-peer solutions (which are becoming widespread) when exchanging music or when jointly calculating extensive algorithms.

In a step 2a, the node SX1 first inquires of the node SU whether it is prepared to act as backup for the node SX1. The response from the node SU turns out to be negative. Possible reasons are that the node is already overloaded or has exceeded a maximum permissible access limit. Another possibility is the lack of a redundant connection between SX1 and SU or an insufficient communication bandwidth.

In a subsequent step 2b, the node SX1 consults the node SX2 and obtains a positive response there. SX1 and SX2 then enter into a virtual connection that is temporary under certain circumstances, that is to say a virtual cluster NX is formed from the two nodes SX1 and SX2. Therefore the “session” started with client A is replicated on the node SX2, that is to say the data interchanged between client A and SX1 is replicated as contexts on the node SX2 and processes on SX2 are configured as backup processes for the same processes on the node SX1.

A database that is administered via a standard interface is used for configuration. Special programming interfaces are available for this purpose. Fundamental configuration parameters for this are:

a) processes and their functions in the virtual cluster;

b) connections between the nodes (e.g. SX1 and SX2) and their parameters, high-speed networks such as, for example, gigabit Ethernet or 100baseT Ethernet are normally used between the nodes;

c) naming conventions of the administered objects (contexts, timers, files etc.);

d) monitoring parameters (e.g. waiting time until a system failure is ascertained);

e) audit parameters concerning the objects to be monitored and associated recovery measures;

f) signaling channels for signaling events and alarms; and

g) storage of statistical information.

The following situation exists at the end of step 2. A desired trip has been identified by inquiring availability with various service providers. Trips of interest, for example on the basis of the prices offered, have been selected by accessing the corresponding service providers. The node SX2 has in this case been configured as the backup node for SX1 and can ensure the requisite availability even in the event of a fault. The node SX1 now obtains, on the instructions of client A, definite offers from various travel providers, which also contain, for example, the availability of specific dates, and offers them to client A for selection.

In FIG. 5, the nodes SY1, SY2 and SY3 represent various travel providers. In this case, nodes that have not been incorporated in the virtual cluster NX are thus accessed. Steps 3a, 3b and 3c for inquiring with the travel providers SY1, SY2 and SY3 are independent of the selected node SX1 or SX2 since both nodes, owing to the formation of the cluster, may be regarded as being equal in terms of making the inquiry.

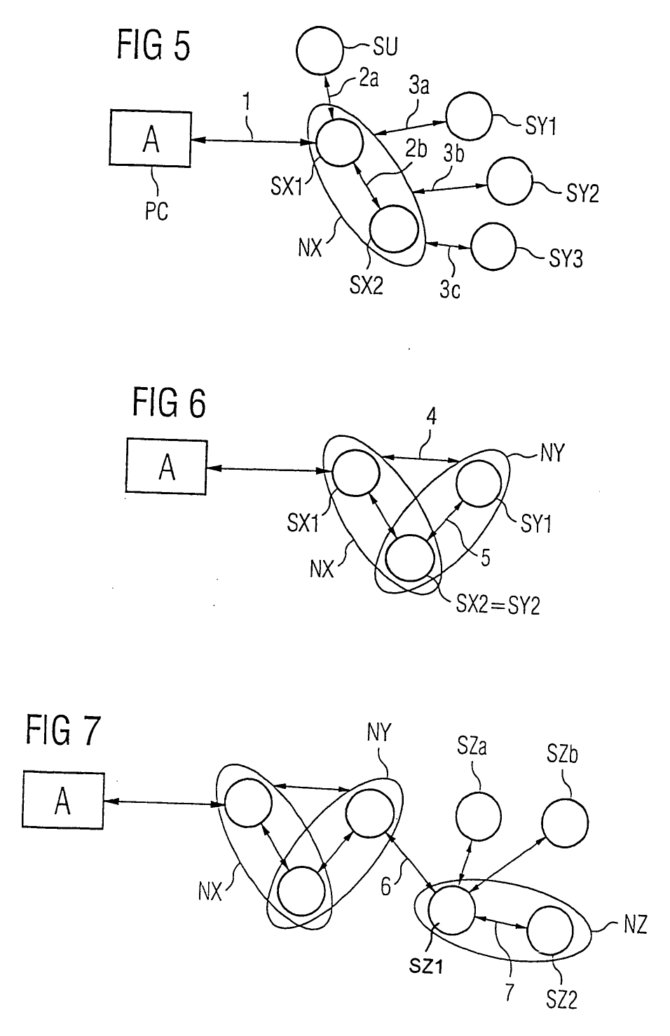

FIG. 6 shows a further phase in the process of booking a trip. In a step 4, a trip is selected for definite and the booking is made. For this purpose, it is assumed that one of the three nodes SY1, SY2 or SY3 has the desired offer. In the example, it is assumed that this is the node SY1. Owing to the financial importance of booking a trip, the node SY1 must also have a high level of availability and therefore enters into a connection (needed to provide functions that increase availability) with a second node SY2. This is made possible by the inventive coupler coupling the nodes SY1 and SY2.

SY1 has already previously determined SY2 as the backup computer (step 5). SY2 is therefore already in a high-availability relationship with respect to SY1 and thus forms a virtual cluster NY with the latter. An advantageous trait is that SY2 may be identical to SX2. The same node is therefore part both of the virtual cluster NX and of the virtual cluster NY. This also constitutes an advantage over conventional local clusters since, in conventional clusters, it is not possible to incorporate a node or server in two clusters.

Therefore, in the event of a fault in SY1, a booking enquiry is directed from the node SX1 to the node SY2. This is shown in FIG. 6 by virtue of the connection for step 4 being between the two virtual clusters NX and NY, not between specific nodes in these clusters. Should SX1 also fail in addition to SY1, the inquiry of client A is answered solely by the node SX2=SY2 since both the connection service to client A and the booking service which client A has selected run there.

Finally, in the illustration in FIG. 7, the travel documents are prepared for the customer and the customer is billed in steps 6 and 7. If desired, online debiting may also be effected.

In step 6, the suitable node for making the booking and for account settlement is first sought. The node results, for example, from the bank that the customer has specified for automatic debiting.

A node of this type is the node SZ1 in the illustration in FIG. 7. In contrast to the preceding steps, a configuration in which the service used is carried out in a completely different virtual cluster is shown here. It is, of course, important for high availability that the connection 6 is also redundant in order to make it possible to use a plurality of connection paths even in the event of a fault. This is also associated with the selection of a suitable partner node. It should also be noted that the network NX no longer has a direct relationship with respect to a network NZ that is formed by the node SZ1 and a second node SZ2. This is due to the fact that the selected travel service provider in the network NY is using the booking service provider in the network NZ. Furthermore, the travel provider has no control over, or information on, the network NZ.

A plurality of steps may in turn be required within the virtual cluster NZ or in order to set up the latter. By way of example, the node SZ1 first tries to address a node SZa or a node SZb in order to form a virtual cluster with them. In a bank, however, it is conceivable that the node SZa will not be suitable for making bookings but rather will be intended only to provide customer information. The possibility of forming a cluster is therefore prevented by appropriately configuring the node SZa.

Within the virtual cluster NZ, it is of course also possible to switch over between various nodes in the event of a fault if the nodes have corresponding high-availability functionality.

In the example just described, each link in the chain thus has a high level for availability for the purpose of carrying out a complex service. This is not achieved by use of individual nodes with clusters being equipped to have a high level of availability but rather by a flexible connection to other nodes, with the nodes each having the inventive coupler that provides functions that increase availability when two nodes are connected.

In some cases, it may be advantageous to be able to transparently discern, from calling nodes or clients, which nodes are currently incorporated or active. An advantageous option is thus to translate physical addresses of nodes or data processing apparatuses into logical addresses. In this case, the physical addresses may be predefinable or automatically determinable. It is also advantageous if event and alarm messages are routed via the same channels and are centrally accessible, so that suitable countermeasures, for example termination of the service, may be initiated automatically or manually.

It cannot always be assumed that there is a second node or a second data processing apparatus which can provide the same service and furthermore has the suitable inventive coupler in order to enter into an availability-increasing connection with the first node, that is to say to form a virtual cluster. In this case, it proves to be advantageous in turn that the inventive coupler can be implemented solely by software. It is therefore possible, on a node that, although it provides the service sought, does not have the inventive coupling, to install precisely the coupling remotely. This provides the greatest possible flexibility when setting up a virtual cluster.

The instance of application described proceeds in an IP network, namely the Internet. However, the invention is not restricted thereto. The invention is applicable whenever a cluster needs to be formed in a network that has data processing apparatuses that are not identified.

We claim:

1. A coupler for coupling a first data processing apparatus connected to a network, to at least one second data processing apparatus also connected to the network and having a further coupler, the second data processing apparatus not being identified in the network, the coupler comprising:
coupling means, the first data processing apparatus associated with a first network node, the second data processing apparatus associated with a second network node within the network, said coupling means, in conjunction with the second data processing apparatus of the second network node, providing functions for increasing availability.

2. The coupler according to claim 1, wherein the functions for increasing availability are provided automatically.

3. The coupler according to claim 1, wherein said coupling means being set up such that the functions for increasing availability can be administered from another network node.

4. The coupler according to claim 1, wherein the functions for increasing availability of said coupling means in the first data processing apparatus carry out memory replication from the first data processing apparatus to the second data processing apparatus.

5. The coupler according to claim 1, wherein the functions for increasing availability carry out a parallel calculation in the first data processing apparatus and in the at least one second data processing apparatus.

6. The coupler according to claim 1, wherein the functions for increasing availability initiate translation of physical addresses of the at least one second data processing apparatus, the physical addresses being predefinable or automatically determinable, into logical addresses, with a translation being carried out by the first data processing apparatus.

7. The coupler according to claim 1, wherein the functions for increasing availability route event and alarm messages through the same channels, with the event and alarm messages being centrally accessible, so that suitable countermeasures including termination of a service, may be initiated automatically or manually.

8. The coupler according to claim 1, wherein the functions for increasing availability of said coupling means in the first data processing apparatus provide timer objects of the at least one second data processing apparatus in redundant form.

9. The coupler according to claim 1, wherein the functions for increasing availability of said coupling means in the first data processing apparatus has means for monitoring the addressability of the at least one second data processing apparatus.

10. The coupler according to claim 9, wherein said coupling means has further means for terminating the functions for increasing availability by coupling to the at least one second data processing apparatus which can no longer be addressed.

11. The coupler according to claim 1, wherein the functions for increasing availability of said coupling means in the first data processing apparatus automatically install an administration program unit from the first data processing apparatus to the at least one second data processing apparatus.

12. A data processing apparatus, comprising:
a communication interface for connecting the data processing apparatus associated with a first network node to a network; and
coupling means for providing functions for increasing availability in conjunction with at least one further data processing apparatus associated with a second network node, the further data processing apparatus being connected to the network, having further coupling means, and is not identified.

13. A data processing system, comprising:
a first data processing apparatus connected to a network and associated with a first network node;
at least one second data processing apparatus also connected to the network and not being identified in the network, said second data processing apparatus associated with a second network node; and
a plurality of coupling means, one of said coupling means connected to each of said first data processing apparatus and said second data processing apparatus for coupling said first and second data processing apparatus to each other, said coupling means, in conjunction with said second data processing apparatus of the second network node, providing functions for increasing availability.

14. The data processing system according to claim 13, wherein the functions for increasing availability are provided automatically.

15. The data processing system according to claim 13, wherein said coupling means being set up such that the functions for increasing availability can be administered from another network node.

16. The data processing system according to claim 13, wherein the functions for increasing availability of said coupling means of said first data processing apparatus carries out memory replication from said first data processing apparatus to said second data processing apparatus.

17. The data processing system according to claim 13, wherein the functions for increasing availability carry out a parallel calculation in said first data processing apparatus and in said at least one second data processing apparatus.

18. The data processing system according to claim 13, wherein the functions for increasing availability initiate translation of physical addresses of said at least one second data processing apparatus, the physical addresses being predefinable or automatically determinable, into logical addresses, with a translation being carried out by said first data processing apparatus.

19. The data processing system according to claim 13, wherein the functions for increasing availability route event and alarm messages through the same channels, with the event and alarm messages being centrally accessible, so that suitable countermeasures including termination of a service, may be initiated automatically or manually.

20. The data processing system according to claim 13, wherein the functions for increasing availability of said coupling means in said first data processing apparatus provide timer objects of said at least one second data processing apparatus in redundant form.

21. The data processing system according to claim 13, wherein the functions for increasing availability of said coupling means in said first data processing apparatus has means for monitoring the addressability of said at least one second data processing apparatus.

22. The data processing system according to claim 21, wherein said coupling means has further means for terminating the functions for increasing availability by coupling to said at least one second data processing apparatus which can no longer be addressed.

23. The data processing system according to claim 13, wherein the functions for increasing availability of said coupling means of said first data processing apparatus automatically installs an administration program unit from said first data processing apparatus to said at least one second data processing apparatus.
